(19) United States
(12) Patent Application Publication
(10) Pub. No.: US 2024/0175884 A1
(43) Pub. Date: May 30, 2024

(54) AUTOMATED LABRATORY SCHEDULING BASED ON USER-DRAWN WORKFLOW

(71) Applicant: Artificial, Inc., Palo Alto, CA (US)

(72) Inventors: Erik Rose, Hillsborough, NC (US); Benjamin C. Leedom, Austin, TX (US); Jon Fournie, Round Rock, TX (US)

(21) Appl. No.: 18/469,747

(22) Filed: Sep. 19, 2023

Related U.S. Application Data
(60) Provisional application No. 63/428,733, filed on Nov. 30, 2022.

(51) Int. Cl. G01N 35/00

(52) U.S. Cl. CPC G01N 35/0092; G01N 35/00871; G01N 2035/009; G01N 2035/0091; G01N 2035/0094

(57) ABSTRACT

A lab system configures robots to performs protocols in labs. A lab system generates an interface including a representation of lab systems within a lab associated with a schedule of tasks. Each task associated with a pre-scheduled assay. A lab system receives, from a user via the interface, a workflow path through the lab for an assay. The workflow path is associated with an ordered subset of the lab systems used in the performance of the assay. A lab system converts the received workflow into a set of lab system tasks required to perform the assay. Each of the subset of lab systems is associated with a subset of lab system tasks. A lab system modifies the schedule of tasks to include the set of lab system tasks by optimizing a combination of the set of lab system tasks and the tasks associated with pre-scheduled assays.

### CROSS-REFERENCE TO RELATED APPLICATIONS

This application claims the benefit of U.S. Provisional Application No. 63/428,733, filed Nov. 30, 2022, which is incorporated by reference in its entirety.

### BACKGROUND

In traditional lab environments, human operators work throughout the lab to perform protocols with equipment and reagents. For example, a human operator may mix reagents together, manually calibrate a robot arm, and operate a pipettor robot to handle liquids. However, in some instances, a lab may include components (e.g., equipment, robots, etc.) that can be automated to perform protocols.

Though automating protocols may streamline the necessary processes, automation in lab environments poses unique challenges. For one, operators in labs may not be versed in how to use a lab system for automation given their specific scientific backgrounds. Secondly, additional training and automation are needed to ensure optimal use of resources when processes are running in parallel. Further, in cases where manual intervention is needed for a step to handle an error, the automation system needs a way to pick the process back up once the manual step is complete. Processes and systems for automating steps of optimizing the schedules of lab equipment and managing the data needed after manual interference is needed.

### SUMMARY

The following disclosure describes a lab automation system that performs protocols in a lab. In particular, the lab automation system communicates with components (e.g., robots, equipment, and/or reagents) in a lab to perform protocols requested via instructions provided via a lab interface.

In some embodiments, an automated lab management system generates a visual overview of the lab equipment and schedules tasks based on pre-planned experiments to be performed within the laboratory. Users can create a customized workflow path for a specific experiment by drawing a visual path on the screen via the interface, indicating the order of lab equipment usage and the respective tasks associated with each. The automated lab management system then transforms the user-provided workflow into a series of tasks required to complete the experiment. The system incorporates these tasks into the existing schedule, considering optimization and minimizing disruptions to concurrent experiments.

In some embodiments, an automated lab management system may encounter unforeseen interruptions during an experiment. If a task cannot be completed automatically, the system alerts the user and requests manual completion of the affected step. Subsequently, the automated lab management system identifies the parameters needed for the next task in the experiment workflow, generating an interface that displays these parameters for the user's reference. Once the user manually completes the interrupted task and provides the necessary information for the next task, the automated lab management system picks up where it left off, resuming the experiment workflow and ensuring timely completion.

The features and advantages described in the specification are not all inclusive and, in particular, many additional features and advantages will be apparent to one of ordinary skill in the art in view of the drawings, specification, and claims. Moreover, it should be noted that the language used in the specification has been principally selected for readability and instructional purposes, and may not have been selected to delineate or circumscribe the inventive subject matter.

### BRIEF DESCRIPTION OF THE DRAWINGS

FIG. 1 illustrates a system environment for a lab automation system, according to one embodiment.

FIG. 2A illustrates components of a lab, according to one embodiment.

FIG. 2B illustrates an example robot configured to perform protocols in a lab according to one embodiment.

FIG. 2C illustrates an example lab, according to one embodiment.

FIG. 3 illustrates a high-level block diagram of the lab automation system, according to one embodiment.

FIG. 4 illustrates a graphic user interface for the lab automation system, according to one embodiment.

FIGS. 5A-5D illustrate an example graphic user interface for inputting instructions by drawing a visual workflow path, according to one embodiment.

FIG. 6 illustrates an example graphic user interface for inputting data from a manual step, according to one embodiment.

FIG. 7 illustrates a process for configuring a robot to perform steps for a protocol, according to one embodiment.

FIG. 8 illustrates the compilation of a Python script, the identification of actions within the script, the assignment of the identified actions to actors (equipment or humans), and the scheduling and execution of the actions, according to some embodiments.

FIG. 9 illustrates an interface for a visual script creation tool, according to one embodiment.

FIG. 10 is a flowchart of an example method for modifying the scheduler to optimize a drawn lab workflow.

FIG. 11 is a flowchart of an example method for enabling manual data entry for automated workflows.

The figures depict various embodiments of the present invention for purposes of illustration only. One skilled in the art will readily recognize from the following discussion that alternative embodiments of the structures and methods illustrated herein may be employed without departing from the principles of the invention described herein.

### DETAILED DESCRIPTION

### System Overview

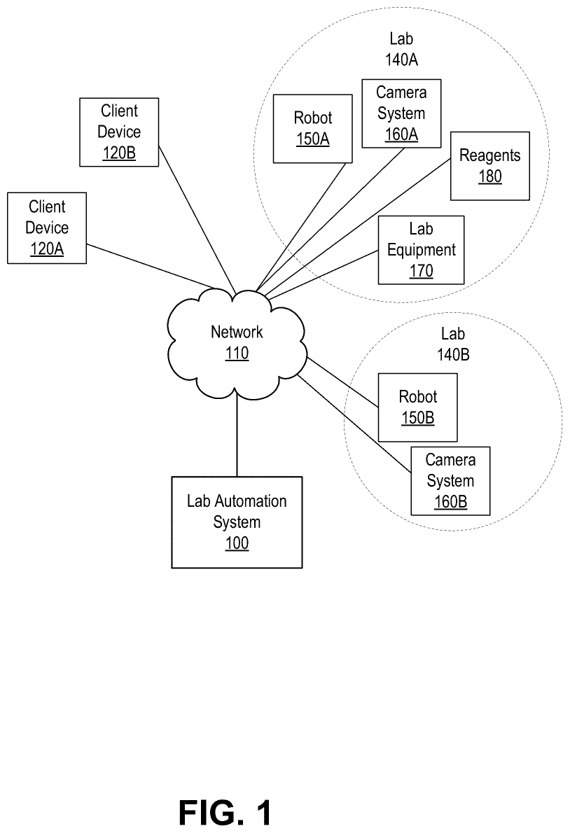

FIG. 1 illustrates a system environment for a lab automation system 100, according to one embodiment. The lab automation system 100 is connected to a number of client devices 120 used by operators of one or more labs 140 via a network 110. These various elements are now described in additional detail.

The client devices 120 are computing devices such as smart phones, laptop computers, desktop computers, or any other device that can communicate with the lab automation system 100 via the network 110. The client devices 120 may provide a number of applications, which may require user authentication before a user can use the applications, and the client devices 120 may interact with the lab automation system 100 via an application. The client devices may present graphic user interfaces displaying information transmitted from the lab automation system 100. Though two client devices 120 are shown in FIG. 1, any number of client devices 120 may be connected to the lab automation system 100 in other embodiments. The client devices 120 may be located within labs 140 connected to the lab automation system 100 or external to the labs. The client devices 120 may present graphic user interfaces for the drawing and visual representation of workflows. Visual representation of workflows may be presented via a client device 120 or a lab-specific computing device. A user may enter information needed by for the workflow after a manual interference of the automation via client device 120, a lab-specific computing device, or via an interface included within the lab equipment itself. As referred to herein, “workflow” or “workflow path” refers to a sequential order of instructions, steps, protocols, tasks, or other procedures or processes that directs the lab system towards a specific outcome or result.

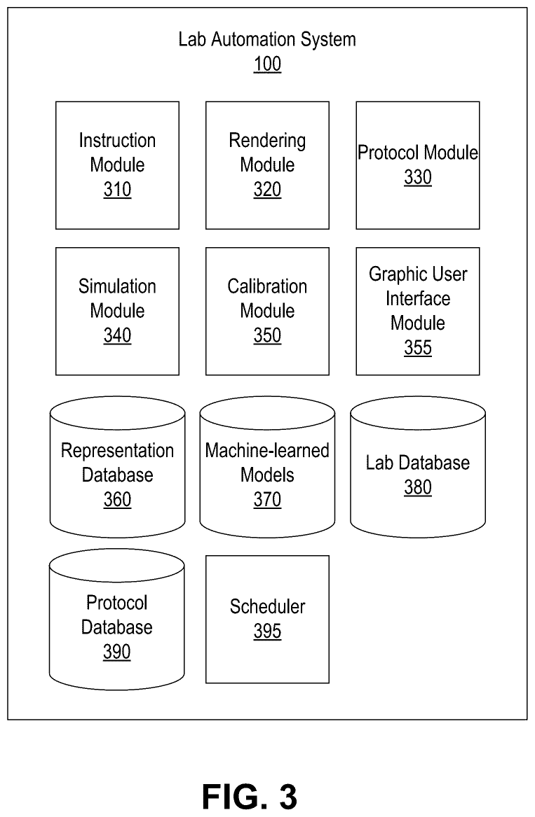

The network 110 connects the client devices 120 to the lab automation system 100, which is further described in relation to FIG. 3. The network 110 may be any suitable communications network for data transmission. In an embodiment such as that illustrated in FIG. 1, the network 110 uses standard communications technologies and/or protocols and can include the Internet. In another embodiment, the network 110 use custom and/or dedicated data communications technologies.

The labs 140 are connected to the lab automation system 100 via the network 110. A lab 140 is a physical space equipped for completing research, experiments, or manufacturing of various products. Each lab 140 includes one or more of robots 150, a camera system 160, lab equipment 170, and reagents 180. The robots 150 may be mobilized to synthesize products or conduct research and experiments in the lab 140. Examples of robots 150 that may be used in the labs 140 are liquid handlers, microplate movers, centrifuges, cappers/decappers, sorters, labelers, loaders, and the like. Each robot 150 may include one or more sensors attached to elements of the robots 150, such as position sensors, inertial measurement units (IMUs), accelerometers, cameras, and the like. Each robot 150 may also include one or more tags attached to external elements of the robot 150. The tags may be visible in image data captured of the lab by the camera system 160, described below, such that the lab automation system may determine positions of the external elements of the robots 150 and calibrate cameras of the camera system 160 based on the tags.

Each lab 140 may include a camera system 160 comprising one or more cameras. The cameras may be video cameras, infra-red cameras, thermographic cameras, heat signature cameras, or any other suitable camera. The cameras of a camera system 160 may be interspersed throughout a lab 140 to capture images and/or video of the lab 140, which may be used by the lab automation system 100 to calibrate the robots 150 and/or lab equipment 170 within the lab.

The lab equipment 170 (or, simply, “equipment”) in the lab is used by the robots 150 and/or human operators to manufacture products from materials (e.g., reagents 180) or conduct experiments/research within the lab. Each piece of equipment 170 may be operated by robots 150, human operators, or both. Examples of equipment 170 may include pipettes, beakers, flasks, plates, storage equipment, incubators, plate readers, washers, centrifuges, liquid handlers, sealers, desealers, or any other suitable equipment used in labs 140. The equipment may be used to synthesize products based on one or more reagents 180 stored in the labs 140. Reagents 180 are substances that may be mixed together for chemical reactions. Examples of reagents 180 stored in the labs 140 may include acetic acid, acetone, ammonia, ethanol, formaldehyde, hydrogen peroxide, sodium hydroxide, and the like. The lab automation system 140, which is further described in relation to FIG. 3, maintains a record of the robots 150, equipment 170, and reagents 180 stored at each lab 140 connected to the lab automation system 100.

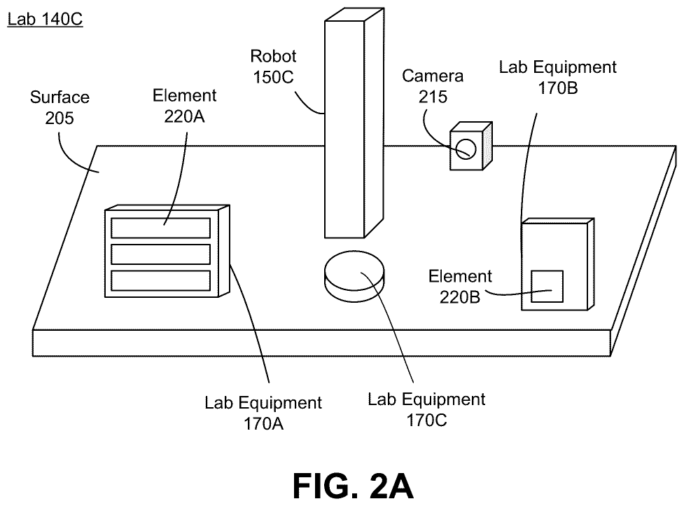

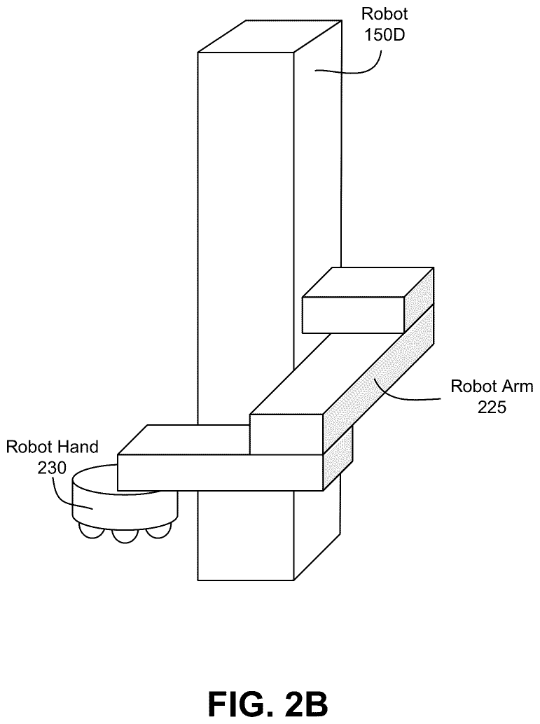

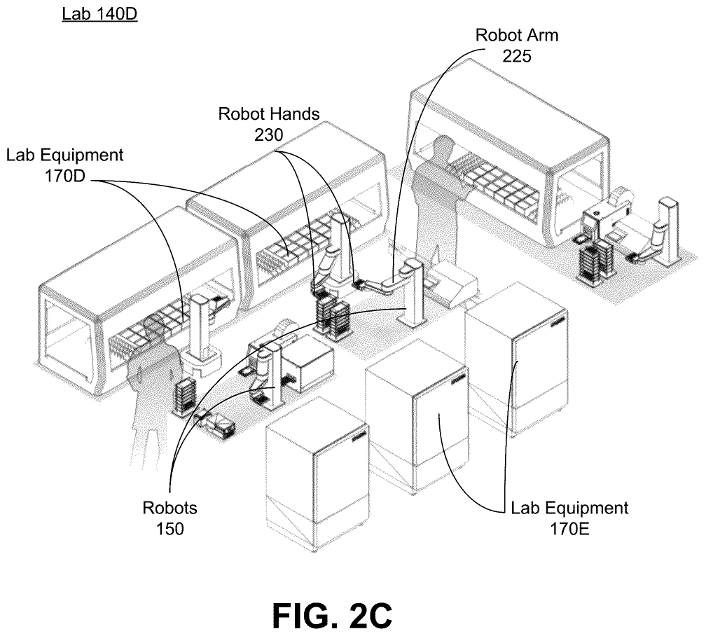

FIG. 2A illustrates components of a lab 140C, according to one embodiment. The lab 140C includes a surface 205 and may include one or more components such as robots 150, equipment 170, and reagents 180. In particular, the lab 140C includes a robot 150C programmable to perform operations in the lab 140C (e.g., by interacting with pieces of equipment 170). In the example of FIG. 2A, the lab 140C additionally includes a camera 215 positioned to receive image data describing the lab 140C. In other examples, the camera 215 may be mounted in different locations in the environment 200 or may be incorporated in the robot 150C or attached to an element 220 of a component.

FIG. 2B illustrates an example robot 150D configured to perform protocols in a lab 140D according to one embodiment. In the embodiment of FIG. 2B, the robot 150D includes components including a robot arm 225 and a robot hand 230. A camera of a camera system 160 in the lab 140D enables the lab automation system 100 to receive image data describing the lab 140D, including the robot 150D and any pieces of equipment 170 in the lab 140D. The robot arm 225 includes one or more jointed, moveable pieces with one or more degrees of freedom of motion, and connects a body of the robot 150D to the robot hand 230. The robot hand 230 includes one or more jointed, moveable pieces configured to interact with the components in the lab 140D. For example, the robot hand 230 can include a set of digits, pincers, or claws for moving and lifting pieces of equipment 170 such as pipettes, beakers, and the like, and for interacting with pieces of equipment 170, e.g., inputting or modifying settings, accessing compartments, and the like. In other embodiments, the robot 150D may include additional, fewer, or different elements than those shown in FIG. 2B, and the robot arm 225 and/or the robot hand 230 may include different elements than those shown in FIG. 2B.

FIG. 2C illustrates a lab 140D, according to one embodiment. The lab 140D includes lab equipment 170 and robots 150 with robot arms 225 and robot hands 230. The robots 150 may interact with the lab equipment 170 to move reagents and other materials for laboratory protocols conducted in the lab 140D. For instance, the robots 150 may access a reagent stored in lab equipment 170E and transfer the reagent to lab equipment 170D using pipettes held by the robot hands 230. Though numerous components are shown in FIG. 2C (e.g., lab equipment such as refrigerators, cabinets, venting systems, etc. and robots such as liquid handlers), other labs 140 connected to the lab automation system 100 may contain other components in other configurations throughout the labs 140. The automation system 100 for a lab 140 may create and execute within the lab 140 an automated workflow, which can include steps performed by both robots and humans.

FIG. 3 illustrates a high-level block diagram of the lab automation system 100, according to one embodiment. The lab automation system 100 includes an instruction module 310, a rendering module 320, a protocol module 330, a simulation module 340, a calibration module 350, a graphic user interface module 355, a representation database 360, one or more machine learned models 370, a lab database 380, and a protocol database 390. In some embodiments, the lab automation system 100 may include additional or alternative modules or databases not shown in FIG. 3.

The instruction module 310 determines steps from a set of instructions. The instruction module 310 receives instructions from the graphic user interface module 355. The instructions indicate how to perform a protocol in a lab 140. The instructions are input received from a user via a graphic user interface displayed via a client device 120, received from a pre-stored workflow, or generated based on a desired functionality specified by a user or a workflow. The instructions may be in the form of text or via a visual drawn path. For example, the text of instructions may indicate to “load holders into Hamilton liquid handler, load aluminum polymer, and pipette polymer into holders.” In another example, the instructions may be a drawing of lines connecting a set of wells from a storage to a Hamilton liquid handler. Furthermore, instructions may be translations of other instructions, or may be based on previously performed instructions. For example, when the instructions indicate that a step be performed by equipment not available within a lab, a translation or adaptation of previous instructions may include instructions to use an alternative piece of equipment with similar properties and uses. The full set of instructions represents a workflow. Some steps within the workflow can be robot performed and some can be human performed. Workflows can be stored for later use.

The instruction module 310 converts the text of the instructions into a set of steps. For instance, the instruction module 310 may identify verb phrases within the instructions that indicate operations that need to be done for the protocol. The verb phrases may each include a verb and one or more dependent words that the verb describes, and each verb phrase may correspond to a step. For example, the instruction may identify three verb phrases in the text “load holders into Hamilton liquid handler, load aluminum polymer, and pipette polymer into holders”: “load holders,” “load aluminum polymer,” and “pipette.” In some embodiments, the instruction module 310 may apply one or more natural language processing methods and/or machine-learned models 370 to determine the steps of the instructions. The machine learned model 370 may be trained on example texts labeled with one or more steps. The instruction module 310 may store the determined steps in association with the text or a colloquial name of the protocol, which may be received with the text from the graphic user interface module 355, in the protocol database 390.

The instruction module 310 identifies one or more of an operation, lab equipment 170, and reagent 180 for each step of the set of steps. An operation may be described by a verb of the verb phrase associated with the step. The operation may be performed using one or more of lab equipment 170, robots 150, and/or reagents 180 (e.g., components), which may be a complement phrase or adjunct phrase explicit in the verb phrase. For instance, the lab equipment 170 and reagent 180 may be represented by one or more nouns following the verb (e.g., “the holders” and “the aluminum polymer” in the step “load the holders with the aluminum polymer.”). In some embodiments, the lab equipment 170 and reagents 180 may be implicit in the step. For instance, the step “load the saline solution” may be associated with the robot “Hamilton liquid handler,” which is used to load reagents in labs 140. In some embodiments, the instruction module 310 may identify the operation, lab equipment 170, robot 150, and/or reagent 180 for each step using one or more natural language processing methods (e.g., creating a syntax tree) and/or machine learned model(s) 370 trained on a set of example steps labeled with operations, lab equipment 170, and reagents 180. The instruction module 310 stores the identified operations, lab equipment 170, and reagents 180 with the associated steps in the protocol database 390.

In some embodiments, the instruction module 310 may determine a lab 140 to perform the protocol in based on the text of the instructions. In some instances, the text may be associated with a particular lab 140 indicated by a user of where to perform the protocol associated with the instructions. In other instances, the instruction module 310 may determine a lab 140 for the protocol to be performed in by parsing the text to identify a noun (and one or more descriptive adjectives) representing a lab 140 and compare the parsed text to an index in the lab database 380 that associates labs 140 with colloquial names used by operators, locations of the labs 140, equipment 170, and reagents 180 stored at the labs 140, and the like. For example, the instruction module 310 may determine the text “prep holders in main street lab” is associated with “Lab 1 on Main Street” of the lab database 380. Further, the instruction module 310 may select a lab 140 based on parameters received with the instructions and additional factors such as schedules of the labs 140, operator availability at each lab, equipment available at each lab, reagents available at the lab, and the like. The parameters may describe a desired protocol location for performing the protocol, a desired proximity to the protocol location, equipment preferences, reagent preferences, budget for the protocol, desired amount of automation for the protocol, desired quality level, and the like.

The instruction module 310 may detect one or more ambiguities in the identified operations, equipment 170, and reagents 180 of the steps. An ambiguity may be a word or phrase of the instructions that the instruction module 310 is unable to map to a component (not including prepositions, articles, and conjunctions). To detect ambiguities, the instruction module 310 may remove articles, conjunctions, and prepositions from the instructions and cross-reference each word with the lab database 380 and/or an external dictionary. If the instruction module 310 is still unable to resolve the ambiguity, the instruction module 310 may send an indication to the graphic user interface module 355 to present one or more words associated with the ambiguity to a user and receives one or more selected words from the graphic user interface module 355. The instruction module 310 updates the steps in the protocol database 390 based on the selected words.

The instruction module 310 may also detect one or more errors in the steps. An error may be a combination of one or more components that could not practically function together to perform an operation or using components to perform an operation that would violate a set of safety protocols. The instruction module 310 may detect errors using a combination of natural language processing and information about labs 140 in the lab database 380. For instance, the instruction module 310 may detect the textual segment “move refrigerator with liquid handler” as including an error since the liquid handler is used to move liquids and could not lift the refrigerator. To resolve an error, the instruction module 310 may send a list of components associated with a step to the graphic user interface module 355 for display to a user. The instruction module 310 receives a selection of one or more components from the graphic user interface module 355 and updates the step in the protocol database 390 to use the selected components. In some embodiments, the instruction module 310 may determine one or more variants for the components or operation and update the protocol with the variants.

The instruction module 310 may determine a set of variants for the components of each step. Variants are alternate components that may be used in place of the lab equipment 170, robots 150, and reagents 180 (henceforth “determined components” for simplicity). Each variant may have the same or alternate (e.g., similar) functionality to a corresponding determined component. For instance, variants with the same functionality may perform or be used for the exact same operations as a corresponding determined component. For example, a first robot may be able to lift up 20 pounds of material for an operation, and a second robot that can lift up to 30 pounds of material would be a variant of the first robot. Variants with alternate functionality may perform or be used for substantially similar operations to the determined components. For example, a first reagent may have a specific reaction when mixed with a second reagent. A variant of the first reagent may be a third reagent 180 that has the same specific reaction with the second reagent 180 (in instances where no other reagents are mixed with the described reagents 180). In some embodiments, the instruction module 310 may also determine variants with limited overlapping functionality to the components. In further embodiments, the instruction module 310 may determine the variants based on parameters received with the instructions. The instruction module 310 may account for the parameters (e.g., cost and time to perform the protocol, skillset required of a human operator, etc.) in determining variants.

The instruction module 310 may determine the variants by accessing an index of the lab database 380 to cross-reference components used to perform the same operations. For instance, the instruction module 310 may determine that the lab equipment “liquid holder,” “pipette machine,” and “handheld dispenser” may all be used to dispense liquid and relate the lab equipment 170 as variants of one another in the lab database 380. In some embodiments, the instruction module 310 may apply a machine learned model 370 to the components to determine the variants. The machine learned model may be trained on components labeled with sets of variants. The instruction module 310 may store the variants with the associated components in the protocol database 390. In some embodiments, the instruction module 310 may determine a set of projections for performing the protocol using each of the one or more variants. Each projection is a list of steps for the protocol using the variant and may include manual (e.g., performed by a human operator) and/or automatic (e.g., performed by a robot 150) steps. The instruction module 310 stores the projections for each variant in the protocol database 390.

The instruction module 310 may also determine variants of the operations of the steps. Variants of the operations are alternate methods of performing the operations. For instance, the operation “separating the reagent into 10 holders” may be mapped to the automatic operation of “dividing” a reagent into equivalent amounts between 10 holders. The instruction module 310 may determine that a human operator manually adding the reagent to each of the ten holders would be a variant of the operation that is a different way of resulting in the same outcome (e.g., the reagent separated into the holders). The instruction module 310 may cross-reference in the lab database to determine variants or may apply a machine learned model 370 to each operation to determine a variant. The machine learned model 370 may be trained on operations labeled by a human operator with a set of variants. The instruction module 310 may store the variants with the associated operations in the protocol database 390. In some embodiments, the instruction module 310 may store the variants with indication of whether a variant is done automatically (e.g., by a robot 150) or manually (e.g., by a human operator).

The instruction module 310 may also determine variants of the labs 140 for performance of the protocol. Alternate labs 140 (e.g., the variants) include enough of the same or similar components and may have enough of the same or similar operations performed in the alternate lab 140 to the selected lab 140 that the protocol can be performed in the alternate lab 140. The instruction module 310 may access the variants of the components and operations from the protocol database 390 and input the components and operations, along with their variants, to a machine learned model 370 configured to select alternate labs based on components and variants. The machine learned model 370 may be trained on labs 140 labeled with components that are in and operations that may be performed in the lab 140. In other embodiments, the instruction module 310 cross-references the components, operations, and the variants in the lab database 380 to select a lab 140 that includes components and may have operations performed in the lab 140 to complete the protocol. The instruction module 310 stores the variants of the labs in association with the labs in the lab database 380 and/or the protocol database 390.

The instruction module 310 sends the set of steps, each with an identified operation, lab equipment 170, robot 150, and/or reagent 180, to the protocol module 330 along with the lab 140 to perform the protocol in. In some embodiments, the instruction module 310 may send one or more variants to the graphic user interface module 355 for selection by a user, and upon receiving a selection, send the selection to the protocol module 330 for performance in the lab 140. In further embodiments, the instruction module 310 may receive requests for variants for a protocol from the protocol module 330 and communicate with the protocol module 330 to determine the variants for the protocol. The instruction module 310 also sends the set of steps and associated operations, lab equipment 170, robots 150, reagents 180, and lab 140 to the simulation module 340 for simulation in a virtual representation of the lab 140. In some embodiments, the instruction module 310 may send one or more variants to the graphic user interface module 355 for selection by a user, and upon receiving a selection, send the selection to the simulation module 340 for simulation in the virtual representation.

In some embodiments, the instruction module 310 may group one or more protocols for performance in a lab. For instance, the instruction module 310 may receive multiple sets of instructions indicating protocols to perform in a lab 140. The instruction module 310 may determine, based on the components required for each protocol, which protocols can be performed simultaneously or sequentially in a single lab 140 and create a grouped protocol including steps of the determined protocols. The instruction module 310 may send the grouped protocol to the protocol module 330 for performance in the lab 140.

The rendering module 320 renders virtual representations of labs 140. A virtual representation (or graphical representation) of a lab 140 includes one or more virtual elements representing components in the lab 140 in positions corresponding to the actual positions of the components in the actual lab 140. The virtual elements may be labeled based on the corresponding components. In some embodiments, the virtual elements may include a virtual operator representing a human operator who may perform manual operations in a lab 140. Examples of virtual representations are shown in FIGS. 2A and 2C. The virtual representation may also include a visual representation of a workflow path through the lab 140 and the associated virtual elements. The visual representation of the workflow path is tied to the specific virtual elements associated with each step of the workflow path, and the rendering module 320 may render the workflow path to include each step as well as a progress bar to allow a user to follow along the virtual representation of the workflow path, step by step.

The rendering module 320 receives image data from a camera system 160 of a lab 140. The image data may depict a lab 140 and include camera and video data of the lab 140. In some embodiments, the rendering module 320 may also receive, from the graphic user interface module 355, a list of components and corresponding coordinates in the lab 140. The rendering module 320 may also receive sensor data from one or more components in the lab 140.

The rendering module 320 creates virtual elements representing each component based on the image data of the component (e.g., if a liquid handling robot is shown in the image data, the rendering module 320 creates a virtual element depicting the liquid handling machine). In some embodiments, the rendering module 320 saves the virtual elements in the representation database 360 and uses the virtual elements for similar components when rendering other new labs 140. The rendering module 320 renders a virtual representation of the lab 140. In some embodiments, the rendering module 320 dynamically localizes a scene of the lab 140 from the image data using a three-dimensional model that performs spatial abstraction to create the virtual representation. In other embodiments, the rendering module 320 renders the virtual representation by mapping the virtual elements shown in the image data to a virtual area representing the new lab 140. For instance, the rendering module 320 may determine a location of a robot 150 based on the image data (and/or sensor data indicating a position of the robot) and maps a virtual element representing the robot 150 to a corresponding location in the virtual area. The rendering module 320 stores the virtual rendering in the rendering module 320 in association with the lab 140.

The rendering module 320 may also store information received from the graphic user interface module 355 about the components in the lab 140 in the lab database 380 in relation to the lab 140. For instance, the rendering module 320 may receive text for labeling the virtual element from the graphic user interface module 355. The rendering module 320 may determine a user associated with the test and stores the text in association with the virtual element and the user in the representation database 360. The rendering module 320 may additionally store the text in association with the component the virtual element represents in the lab database 380 and/or protocol database 390, such that the user may reference the component using the text when requesting protocols be performed in a lab 140. The rendering module 320 may also embed image data into the virtual representation. For instance, the rendering module 320 may embed image data of components form various angels in the lab 140. In another instance the rendering module 320 may embed image data depicting instructions for performing steps of a protocol or a specific operation in the lab 140.

The protocol module 330 configures robots 150 in a lab 140 to perform protocols based on the cues from the scheduler 395. Protocols are sub-portions of a workflow path directed towards specific robots or machines. The protocol module 330 receives a set of steps and associated robots 150, operations, lab equipment 170, and reagents 180 from the instruction module 310. For each step, the protocol module 330 configures the associated with the step to perform the operation associated with the step. The protocol module 330 may additionally configure the robot 150 to interact with the lab equipment 170 (if any) and access and use the reagent 180 (if any) associated with the step to perform the operation. The protocol module 330 can implement and execute the steps of different workflow paths in a lab 140 simultaneously. In some embodiments, the protocol module 330 may request variants for the protocol from the instruction module 310 and modify the protocol with one or more variants. The protocol module 330 may, in some instances, request for the simulation module 340 to simulate the protocol with one or more variants to determine an experimentation time for the protocol. The experimentation time is the estimated amount of time needed to complete the protocol in the lab 140. The protocol module 330 may select the variants associated with the lowest experimentation time and modify the protocol in the protocol database 390 to use those variants. As the protocol module 330 executes the protocols and updates the protocols to be implemented, the protocol module 330 may provide the scheduler 395 with updates on the completion of protocols and next steps.

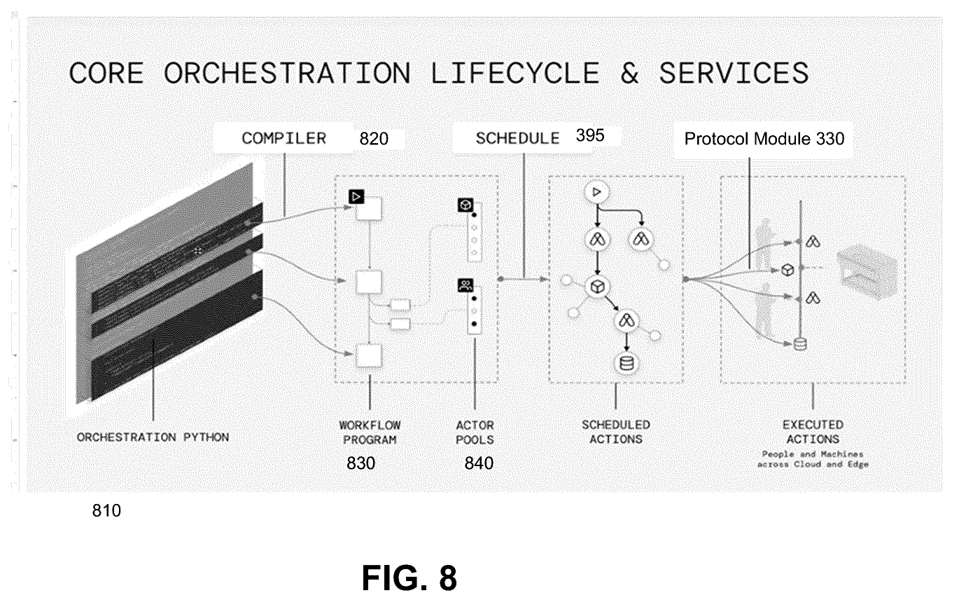

The scheduler 395 schedules the actions and steps that make up a workflow path, and assign the steps to the appropriate piece of laboratory equipment. The scheduler 395 provides the steps and assignments to the protocol module 330 which configures the equipment to execute and implement the assigned steps. In some embodiments, the scheduler 395 receives the actions of a visual workflow path and based on the subset of lab systems associated with the tasks of the visual workflow, the scheduler 395 assigns the tasks to the related lab systems for the protocol module 330 to configure and execute. The scheduler 395 may provide instructions to the protocol module 330 to pause or otherwise modify the timing of a task in a workflow path in order to optimize the resource allocation across the lab 140. In some embodiments, in response to a stoppage or error, a workflow is stopped and a user associated with the lab 140 manually performs a given task instead of the assigned lab system. In response to a user performing an action manually in cases which the scheduler 395 has scheduled a robot, the scheduler 395 may pause the workflow and resume then resume the workflow once the scheduler 395 receives the user's manual input of data related to the task. In other embodiments, the scheduler 395 may re-schedule the remaining portion of the paused workflow based the resources currently available within the lab 140. For example, if during the pause of the workflow, the resources available within the lab 140 have changed, the scheduler 395 may re-schedule the remainder of a workflow path based on the updated status within the lab 140. The scheduler 395 is described further below as part of FIG. 8.

The simulation module 340 simulates protocols occurring within labs 140. The simulation module 340 receives request to simulate a protocol in a lab 140. The request may be from the graphic user interface module 355. The simulation module 340 may request a set of steps for the protocol from the instruction module 310 or access a set of steps for the protocol from the protocol module 390. In another embodiment, the request may be in the form of receiving a set of steps to be performed in a lab 140 and associated operations, lab equipment 170, robots 150, and reagents 180 from the instruction module 310.

The simulation module 340 accesses a virtual representation of the lab 140 in the representation database 360. For each step received from the instruction module 310 for the protocol, the simulation module 340 determines which virtual elements of the virtual representation correspond to the components associated with the step. The simulation module 340 determines, based on the operation associated with the step, how the one or more components would need to move within the lab 140 for the operation to be performed and moves the corresponding virtual elements accordingly in the virtual representation of the lab 140. The simulation module 340 may additionally highlight the virtual elements in the virtual representation. The simulation module 340 accesses the lab database 380 to determine whether the movement of components associated with the virtual elements would cause any issues during performance of a protocol. Issues may include robots 150 or lab equipment 170 overlapping, a robot 150 being unable to perform an operation, lack of availability of lab equipment 170 and reagents 180 in the lab 140, and the like, and the lab database stores information describing which components have the ability to stack, overlap, and interact with other components. The simulation module 340 sends the virtual representation with the moved virtual elements and any detected issues to the graphic user interface module 355 for each step.

The simulation module 340 also simulates protocols occurring within a lab 140 in real-time. The simulation module 340 receives requests from the graphic user interface module 355 for simulations of protocols being currently performed in labs 140. For a request, the simulation module 340 accesses a virtual representation of a lab 140 in the representation database 360. The simulation module 340 receives sensor data from robots 150, equipment 170, and a camera system 160 in a lab 140. The sensor data may include image data of the lab 140, position data of components of the robots 150 and/or equipment 170, and any other suitable sensor data. Based on the sensor data, the simulation module 340 determines how the components within the lab 140 have been moved as a protocol is performed and moves corresponding virtual elements in the virtual representation of the lab 140 to mirror the movement of the components. The simulation module 340 may additionally highlight virtual elements corresponding to components being used or moved I the lab 140. The simulation module 340 sends an indication to the graphic user interface module 355 that the virtual representation of the lab 140 is being updated to show the protocol being performed in real-time. Once the protocol is completed, the simulation module 340 stores the virtual representation of the lab 140 showing the current state of the lab 140 (e.g., the current positions of the components in the real world lab 140) in the representation database 360.

The simulation module 340 may also simulate variants of a protocol. The simulation module 340 may receive requests from the graphic user interface module 355 to simulate one or more variants for a protocol. In some embodiments, the request may be associated with a set of parameters. The parameters may describe a desired protocol location for performing the protocol, a desired proximity to the protocol location, equipment preferences, reagent preferences, and the like. The simulation module 340 may select one or more variants to simulate for the protocol to optimize satisfying the parameters (e.g., selecting operations that take less time, cost within the budget, etc.). The simulation module 340 modifies a copy of the virtual representation of the lab 140 to depict the simulation of each variant. In some embodiments, the simulation module 340 may modify the copies in different colors depending on the type of variant. For example, the simulation module 340 may modify the copies to show variants that occur automatically in a first color and variants that occur manually in a second color. The simulation module 340 may store the modified copies in the representation database 360 in association with the variants.

In some embodiments, the simulation module 340 may receive a list of projections for a variant and simulate the projections in the lab 140. A projection is a list of steps and associated operations and components necessary to perform the entire protocol. The simulation module 340 may determine, for each projection, potential errors that may occur if the protocol were performed according to the projection, such as running out of lab equipment 170 or reagents 180, robots 150 blocking one another in the lab 140, scheduling conflicts, and the like. The simulation module 340 modifies a copy of the virtual representation based on simulation of the projections and sends the modified virtual representation to the graphic user interface module 355 for display after completion of the simulation of each step.

The calibration module 350 calibrates cameras of the camera systems 160 connected to the lab automation system 100. The calibration module 350 receives requests to calibrate one or more cameras from the graphic user interface module 355. In some embodiments, the calibration module 350 may periodically calibrate the cameras connected to the lab automation system 100 without receiving an explicit request from the graphic user interface module 355. The calibration module 350 requests image data from the one or more cameras and associates subsets of the image data with its respective camera that captured the image data. The calibration module 350 stores the image data in the lab database 380 in association with the lab 140 and the camera.

For each camera of the one or more cameras, the calibration module 350 determines which lab 140 the camera is located in and requests sensor data from sensors connected to one or more components in the lab 140. The calibration module 350 stores the sensor data in the lab database 380 along with identifiers of the components and the lab 140. The calibration module 350 determines a position of one or more elements 220 of each component based on the sensor data. For instance, the sensor data may indicate position coordinates of a robot arm 225 and robot hand 230 of a robot 150 in the lab 140. In another instance, the position data may indicate the position of an element 220 of a robot 150 relative to a stationary base of the robot 150, the coordinates for which the calibration module 350 may access in the lab database 380.

The calibration module 350 locates tags physically attached to the components in the image data. Each tag may include information encoded on the tag indicating which element 220 of a component the tag is on and may vary in shape, size and color. The calibration module 350 may store information describing where the tags are located and shape, size, and color of the tags in the lab database 380. The calibration module 350 may apply a machine-learned model 370 to the image data to locate tags within the image data. The machine-learned model 370 may be trained on image data with pixels labeled as including a tag or not and coordinates of the tag and may be a classifier, regression model, decision tree, or any suitable model. The calibration module 350 may further determine depth information about the image data based on the tags shown in the images and each tag's associated shape, size, and color.

The calibration module 350 determines the location of the camera based on the determined positions of the components and locations of tags, such as by triangulating. In some embodiments, the calibration module 350 may also account for distortion of the lens of the camera. The distortion may have been previously entered for the camera by an external operator or the calibration module 350 may determine the distortion based on the locations of the tags and/or positions of the components. The calibration module 350 calibrates each camera based on the camera's determined location such that the calibration module 350 may determine locations of other components shown in image data captured by the camera given the camera's determined location.

The calibration module 350 may determine the location of components in a lab 140 using image data from calibrated cameras. The calibration module 350 may receive a request for the location of a particular component in a lab 140 or may periodically determine locations of components in each lab 140. The calibration module 350 accesses image data captured by one or more calibrated cameras in the lab 140 and locates one or more tags that are visible on the particular component. The calibration module 350 determines the location of the particular component based on the location of the one or more tags.

In some embodiments, the calibration module 350 may determine that a camera needs recalibration based on new image data captured by the camera. The calibration module 350 receives new image data from the camera in real-time and determines one or more components shown in the new image data. The calibration module 350 may also request new sensor data from the one or more components (if available, such as when one or more of the components is a robot 150 with an internal camera) in the new image data. The calibration module 350 retrieves historical image data and corresponding historical sensor data from the lab database 380 captured by the camera and determines which components have not moved in the lab 140 based on the historical sensor data and the new sensor data. The calibration module 350 compares the location of the components that have not moved between the historical image data and the new image data. In some embodiments, the calibration module 350 may do so using a machine-learned model 370 trained on sets of image data labeled with discrepancies (e.g., a component appearing in unexpected pixels in the image data). If the calibration module 350 determines that a component does not appear where expected, the calibration module 350 recalibrates the camera. Alternatively, the calibration module 350 may determine which pixels of the image data should show the component in an expected location based on the new sensor data and analyze the new image data to determine if the component is in the expected location. The calibration module 350 recalibrates the camera if the component is not shown in the determined pixels.

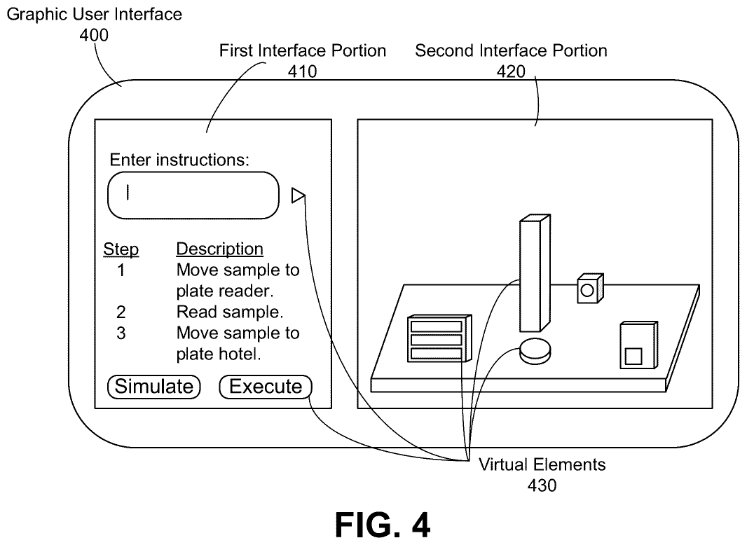

The graphic user interface module 355 generates graphic user interfaces for display on one or more client devices 120 connected to the lab automation system 100. Examples of graphic user interfaces are described with respect to in FIGS. 4-6. The graphic user interface module 355 receives, from a client device 120, a request to view a virtual representation of a lab 140. The graphic user interface module 355 retrieves the virtual representation from the representation database 360 or requests a virtual representation from the rendering module 320. The graphic user interface module 355 renders the virtual representation in the graphic user interface. The virtual elements of the virtual representation may be interactive elements that a user may interact with. For instance, upon receiving a mouseover of a virtual element via the graphic user interface, the graphic user interface module 355 may cause the virtual element to become highlighted within the virtual representation or mimic an operation being performed. Further, upon selection of a virtual element, the graphic user interface module 355 may present a tag element connected to the virtual element. A user may enter text to the tag element to label the virtual element and its associated component with. The graphic user interface module 355 sends the text to the rending module 320 for addition to the virtual representation in the representation database 360.

The graphic user interface module 355 may receive as input instructions via a drawn path between virtual elements. The graphic user interface module 355 may also render the instructions that form the workflow path visually as a drawn path through the lab, connecting the virtual representations of each piece of lab equipment. Upon a selection of a virtual element, the graphic user interface 355 may present options to the user regarding how the user can connect the virtual elements. For example, options may include whether the path splits at a given virtual element, or loops back.

The graphic user interface module 355 renders one or more interactive elements in the graphic user interface. The interactive elements may allow a user to move virtual elements associated with components in a lab, enter coordinates of components in a lab, request a simulation of a protocol, request calibration of one or more cameras, request variants for a protocol, and the like. The interactive elements may also allow a user to select a mode for the graphic user interface to operate in. For example, a first mode may cause the graphic user interface to display simulations of protocols in a virtual presentation and a second mode may cause the graphic user interface to mimic, in real-time, protocol that is currently being performed in a lab.

The graphic user interface module 355 may display one or more simulations of protocols in a lab via the graphic user interface. The graphic user interface module 355 receives, via an interaction with an interactive element of the graphic user interface, a request to simulate a protocol in a lab 140. The graphic user interface module 355 requests a simulation of the protocol in the lab from the simulation module 340. The graphic user interface module 355 receives a virtual representation of the lab with virtual elements moved for each step of a protocol and presents the virtual representation via the graphic user interface. In some embodiments, the graphic user interface may include an interactive scrolling element that allows a user to increment through each step in the virtual representation. The graphic user interface module 355 may receive detected issues for each step from the simulation module 340 and presents the detected issues as alerts via the graphic user interface. The detected issues to the graphic user interface module 355 for each step.

In some embodiments, the request for the simulation may include one or more parameters. Examples of parameters include a desired experimentation time for the protocol, a budget, a necessary skillset for human operators, necessary equipment 170 and/or reagents 180, and the like. The graphic user interface module 355 sends the request with the parameters to the simulation module 340, which determines one or more variants to simulate to satisfy the parameters. Upon displaying the simulation in a virtual representation, the graphic user interface module 355 may display statistics representing whether the parameters are satisfied or not using the one or more variants.

The graphic user interface module 355 may also receive, via an interaction with an interactive element of the graphic user interface, a request to simulate a protocol that is currently occurring in a lab 140. The graphic user interface module 355 requests a simulation of the protocol the simulation module 340. The graphic user interface module 355 receives indications from the simulation module 340 as the simulation module 340 updates the virtual representation of the lab 140 in the representation database 360. The graphic user interface module 355 displays the updated virtual representation in real-time via the graphic user interface. In some embodiments, the graphic user interface module may also send notifications in response to receiving a request. For instance, if the graphic user interface module 355 receives a request for variants of a robot 150 in a lab 140 but the instruction module 310 indicates that none exist, the graphic user interface module 355 displays a notification on the graphic user interface indicating that no variants are available for the robot 150.

The graphic user interface module 355 may receive instructions via a text box of the graphic user interface. The instructions may be associated with a lab 140 and, in some embodiments, a set of parameters. The graphic user interface module 355 sends the instructions with the lab 140 and parameters to the instruction module 310. The graphic user interface module 355 may receive an indication of an ambiguity or error in the instructions from the instruction module 310. The graphic user interface module 355 may present one or more words associated with an ambiguity via the graphic user interface and receive a selection of one or more words via the graphic user interface, which the graphic user interface module 355 sends to the instruction module 310. The graphic user interface module 355 may also present one or more components associated with an error via the graphic user interface and receive a selection of one or more components via the graphic user interface, which the graphic user interface module 355 sends to the instruction module 310.

The graphic user interface module 355 may receive one or more variants from the instruction module 310 and displays the one or more variants in a selectable list via the user interface. For example, the variants may be a list of alternate labs 140 for the lab 140 for a user to select from. The graphic user interface may highlight, in the virtual representation, virtual elements of components associated with a variant upon receiving mouseover of the variant in the selectable list. In another embodiment, the graphic user interface module 355 may highlight virtual elements representing the variants in the virtual representation such that a user may interact with a highlighted virtual element to select a variant. The graphic user interface module 355 sends selected variants to the instruction module 310.

FIG. 4 illustrates a graphic user interface for the lab automation system 100, according to one embodiment. In other examples, the graphic user interface 400 may include additional, fewer, or different elements than those shown in FIG. 4. The graphic user interface 400 may be generated by the graphic user interface module 355 described previously. In the example of FIG. 4, the graphic user interface 400 includes a first interface portion 410 and a second interface portion 420. The first interface portion 410 enables a user of the lab automation system 100 to provide instructions in natural language to the lab automation system 100, which identifies operations, equipment, and/or reagents corresponding to the provided instructions, as described in reference to the instruction module 310. In some embodiments, the first interface portion 410 additionally enables a user to simulate or execute a protocol responsive to steps being generated for provided instructions.

The second interface portion 420 includes a view of a lab 140. In some embodiments, the second interface portion 420 is a virtual representation of the lab 140 generated by the rendering module 320. Users of the graphic user interface 400 may modify the virtual representation by interacting with virtual elements 430 via the graphic user interface 400 and may request simulations of robots 150 performing the steps of a protocol for visualization or display within the virtual representation. In other embodiments, the second interface portion 420 is a live feed, representation, or view of the lab 140 captured via a camera system 160. In these embodiments, the second interface portion 420 displays the lab 140 in real-time or in near real-time as robots 150 perform protocols.

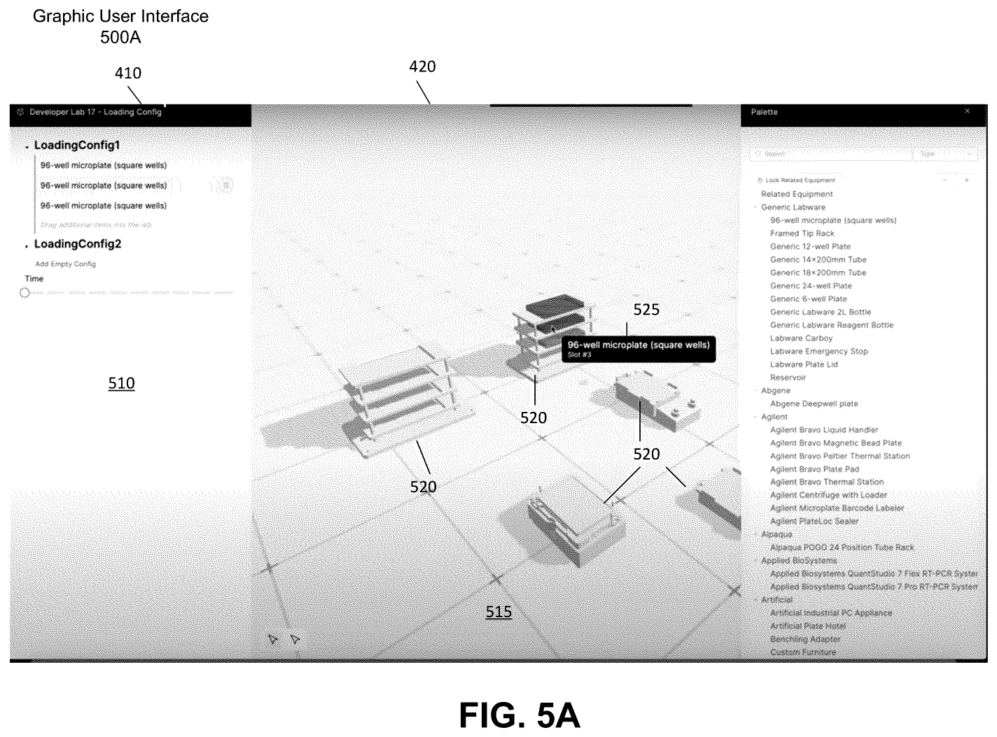

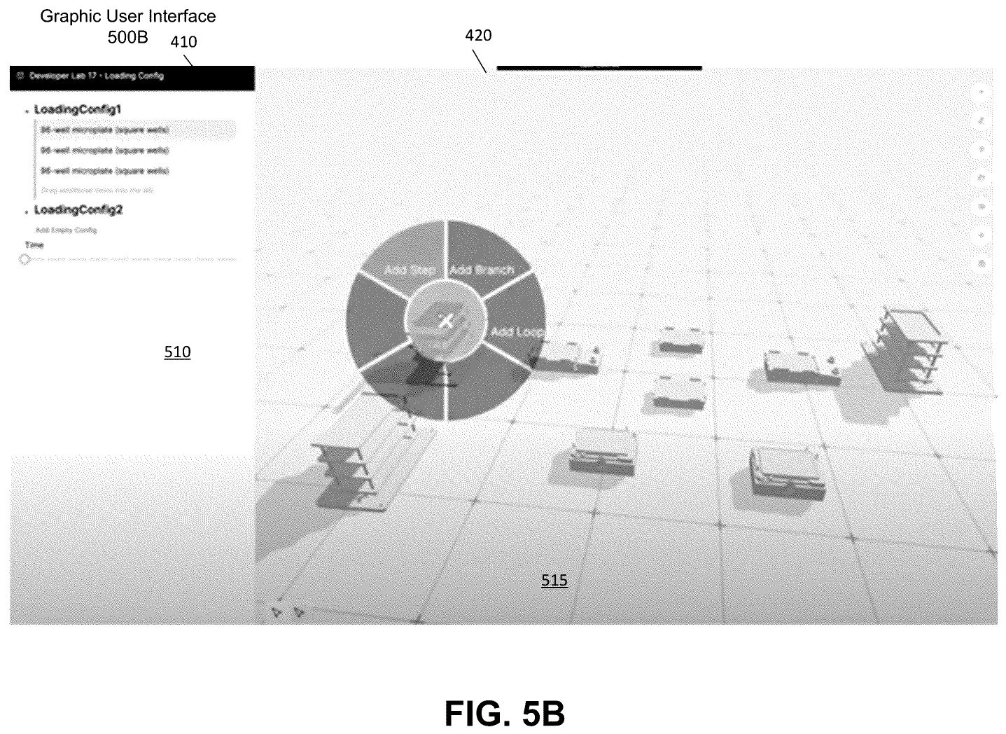

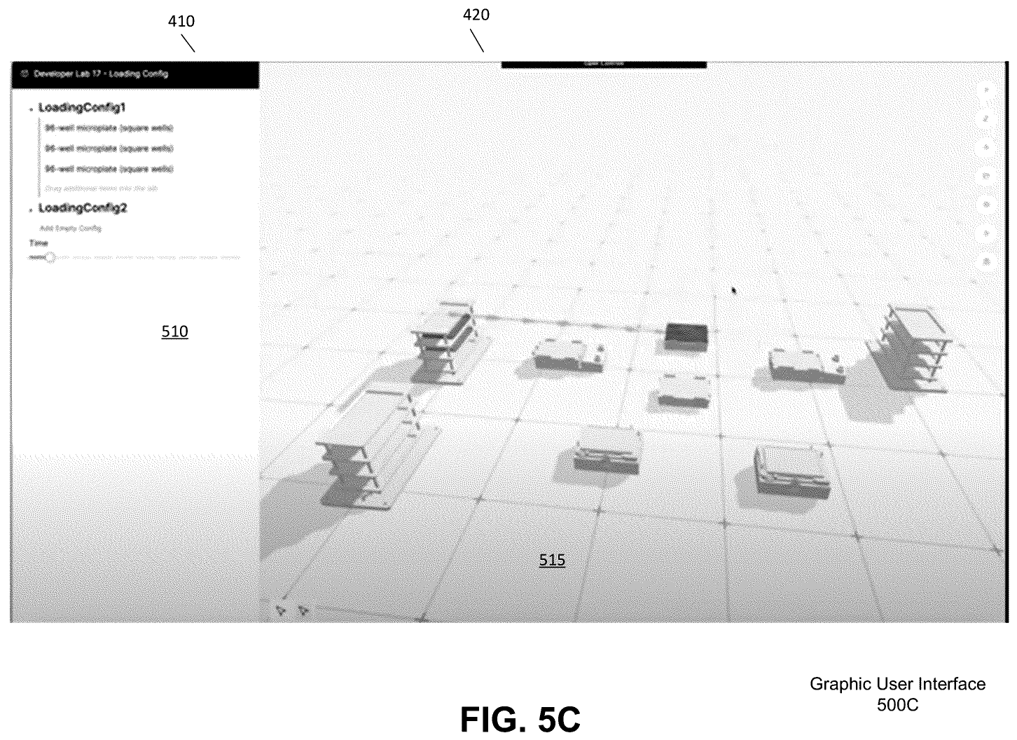

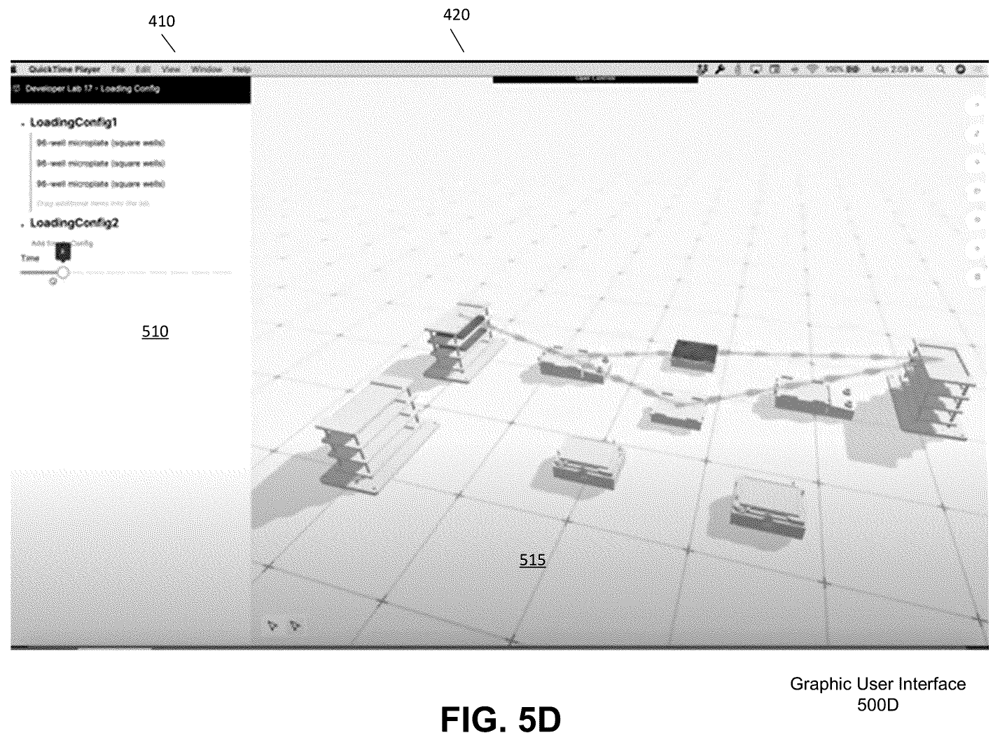

FIGS. 5A-5D illustrate an example graphic user interface 500A for inputting instructions by drawing a visual workflow path, according to one embodiment. In particular, in FIG. 5A, the first interface portion 410 of the graphic user interface 500A includes a textbox 510, and the second portion 420 includes a virtual representation 515 of a lab 140. The textbox 510 displays the current state of the workflow path. Upon a mouseover by the user on a virtual element 520, an identification 525 of the virtual element 520 appears on the screen accordingly.

In FIG. 5B, the second portion 420 of graphic user interface 500B includes, upon selection of a virtual element, an option menu 530. The option menu 530 includes options relating to the workflow path options associated with that virtual element. For example, the option menu 530 may include options such as “Add Step”, “Add Branch” and “Add Loop”, providing the option of adding steps to the workflow, branching the workflow, or adding a loop to the workflow path respectively.

In FIG. 5C, the first portion 410 of graphic user interface 500C includes the textbox 510, as well as progress bar 540, indicating the stage of the workflow path presented on the screen. The second portion 420 of the graphic user interface 500C includes the first virtual element 520 and the second virtual element 550 now connected by a visual workflow path 560. Once a step is added to the workflow path, the visual representation of that step is added to the graphic user interface as shown. In FIG. 5D, the second portion 420 of the graphic user interface 500D displays a visual workflow path 560 with multiple steps, and a branching portion, which connects multiple virtual elements of the lab 140.

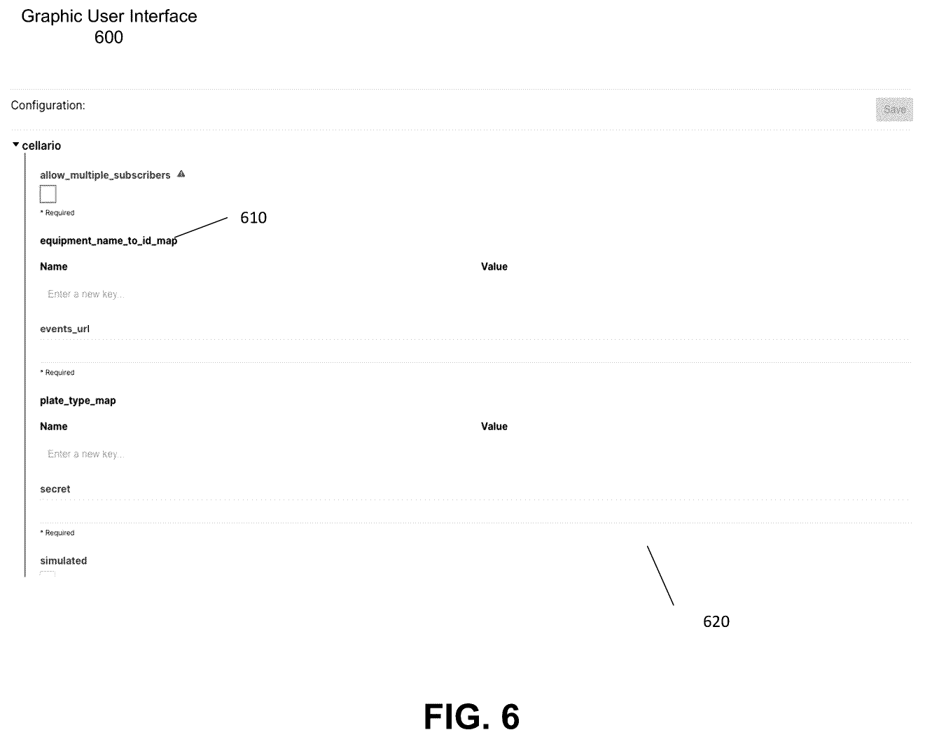

FIG. 6 illustrates an example graphic user interface 600 for inputting data from a manual step, according to one embodiment. In particular, the graphic user interface 600 includes am equipment identification 610, and a form 620. The form 620 includes a series of textboxes with labels for specific metrics as well as textboxes for a user to enter specific values. The metrics required for each form 620 are determined based on the task that was paused, the metrics identified in the system as required for that task, the values required for the larger workflow, and the values that are required for tasks downstream in the workflow. Specific metrics may be identified in the system as required or optional for a given step, task, and/or workflow. The form 620 is generated for a user when the system detects that an error has occurred which requires a human user to perform the step. The form 620 is generated to list the values that the workflow requires before it can proceed. In some embodiment, the form 620 may indicate in certain textboxes that some values have a default value if not entered by the user.

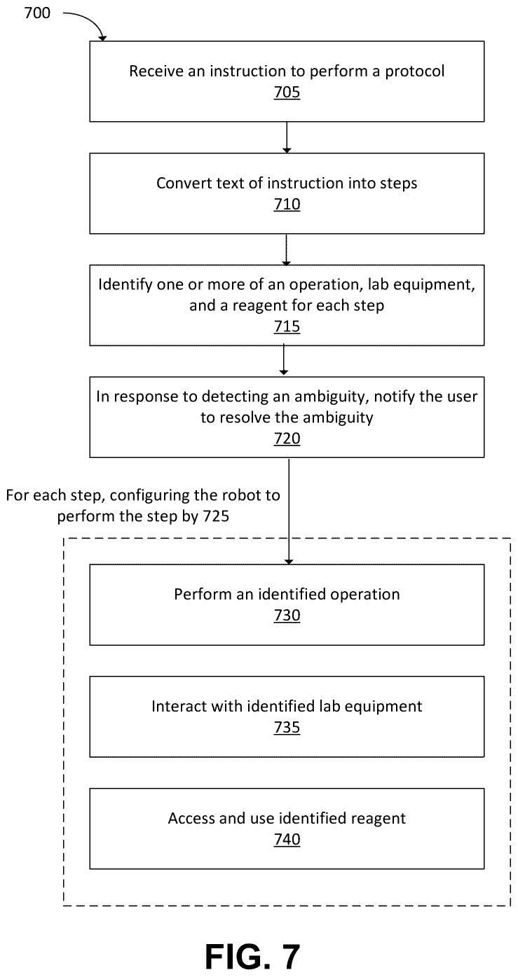

FIG. 7 illustrates a process 700 for configuring a robot 150 to perform steps for a protocol, according to one embodiment. In particular, the graphic user interface module 355 receives 705, via a graphic user interface, an instruction from a user to perform a protocol within a lab 140. The instruction may include text indicating the instructions and the lab 140 to perform the protocol associated with the instructions in. The graphic user interface module 355 sends the instructions to the instruction module 310, which converts 710, using a machine learned model 370, the text into steps. Each step may be a segment of the text indicating an action to be performed for the protocol. In some embodiments, the machine learned model 370 may use natural language processing to extract generic capabilities (e.g., actions) from the text.

For each step, the instruction module 310 identifies 715 one or more of an operation such as the action, lab equipment 170, and reagent 180 associated with the step. For instance, the instruction module 310 may access the lab database 380 to determine which components are available in the lab 140 and select only available lab equipment 170 and reagents 180 for the step. In response to detecting an ambiguity or error associated with the step, the instruction module 310 alerts the graphic user interface module 355, and the graphic user interface module 355 notifies 720 the user via the graphic user interface of the ambiguity or error. For each step, the protocol module 330 configures 725 a robot 150 to perform 730 an identified operation, interact 735 with identified lab equipment 170, and/or access and use 740 an identified reagent 180 associated with the step.

It is appreciated that although FIG. 7 illustrates a number of interactions according to one embodiment, the precise interactions and/or order of interactions may vary in different embodiments. For example, in some embodiments, the instruction module 310 may determine a det of candidate actions for the ambiguity or error and select a candidate action with more than a threshold likelihood of resolving the ambiguity or error. The instruction module 310 may send the candidate operation to the graphic user interface module 355, which displays an indication of the step associated with the ambiguity or error via the graphic user interface. The graphic user interface module 355 may also display, in a virtual representation of the lab 140, a representative action associated with the candidate operation, such that the user can see what the candidate operation would look like being performed in the lab 140. In other embodiments, the instruction module 310 may determine a list of one or more candidate operations, lab equipment 170, and/or reagents 180 that may resolve the ambiguity or error, and the graphic user interface module 355 may display the list via the graphic user interface.

### Automated Lab Scheduling

Pre-programmed laboratory processes can be coded using a programming language, such as Python, Swift, Ruby, Perl, Go, any imperative paradigm programming language, or any other suitable language. For the purposes of the simplicity, the remainder of this description will center on Python embodiments and examples, though it should be noted that the principles described herein apply equally to other programming languages as well.

A pre-programmed laboratory process can include a Python script that includes instructions for (for instance) a workflow or experiment to be performed within a laboratory. This script can be parsed into individual actions, which can be assigned to either robotic equipment (e.g., one or more robots or robotics devices) or humans within one or more labs. An example workflow request associated with an experiment performed using a well plate includes a set of workflow parameters, a set of worklist instructions, a load instruction, a set of run instructions, an unload instruction, and a results instruction.

FIG. 8 illustrates the compilation of a Python script, the identification of actions within the script, the assignment of the identified actions to actors (equipment or humans), and the scheduling and execution of the actions, according to some embodiments. In particular, FIG. 8 illustrates the relationship between the compiling of the python script 810 by the compiler 820, the scheduler 395, and the protocol module 330.

In some embodiments, either before, during, or after compiling a Python script 810 by the compiler 820, a list of candidate actors 840 are identified based on the requirements and characteristics of each action identified within the Python script 810. An actor 840 is any lab equipment, or component of lab equipment, or person in the lab that might perform an action. The list of candidate actors 840 includes candidate robotic equipment and/or candidate people. For each action identified, an actor 840 is selected to perform the identified action. The selection of an actor 840 can be based on any suitable factor, including but not limited to a location in which the identified action is to be performed, available people within a laboratory, expertise associated with the people within a laboratory, current availability or workload of the people within a laboratory, experiment error rates or characteristics associated with the people within a laboratory (e.g., how likely an individual is to make a mistake when perform the identified action), the type of robotic equipment within a laboratory, current availability or workload of the robotic equipment within a laboratory, an amount of time the identified action is estimated to require to perform, dependencies or scheduling associated with other identified actions within the workflow 830, and an order in which one or more of the identified actions are to be performed.

For example, a Python script 810 for a cell-based assay can be converted into the following set of actions: 1) thawing cells, 2) counting cells, 3) assess cell viability, 4) dilute to optimal cell density, 5) dispensing cells to a plate with a set of wells, 6) load other reagents into the set of wells, and 7) incubate cells. In this example, steps 1-3 can be assigned to a lab worker at a lab for manual completion. In response to the lab having robotic dilution equipment, step 4 can be assigned to the robotic dilution equipment for autonomous completion. In response to an autonomous liquid handler (such as a Hamilton liquid handler) having capacity to perform steps 5-6 within a threshold interval of time, steps 5-6 can be assigned to the autonomous liquid handler. If the autonomous liquid handler does not have capacity to perform steps 5-6 within the interval of time (e.g., as a result of having a queue of actions to perform associated with other experiments), steps 5-6 can be assigned to a lab worker for manual performance. Step 7 can be assigned to a lab worker with a highest success rate of monitoring incubating cells.

The actions can be scheduled by the scheduler 395 based on an expected time of performance for the actor 840, which may be robotic equipment or human operators. The expected times to perform each action can be based on historical precedent, for instance an average of previous lengths of time each action takes to perform. In some embodiments, expected times of performance are computed for each actor 840 that can perform that action, including each component of robotic equipment in a lab each person in the lab. In some embodiments, in order to identify candidate actors 840 that can perform one or more of the actions identified within a Python script workflow 830, the one or more steps can be simulated within a virtual representation of a lab, and the expected times of performance for each action can be computed based on the simulation.

In some embodiments, all or a portion of the identified actions must be completed in a particular order. Accordingly, the actions can be scheduled by the scheduler 395 such that each action is scheduled for performance only after all actions upon which the action is dependent is likely to have been performed. To use a simple example, prior to centrifuging cells, different concentrations of cells need to be added to a set of wells. In this example, the centrifuge action is scheduled after an amount of estimated time required for a robotic arm to add the concentrations of cells to the set of wells has passed.

In some embodiments, in response to determining that a particular piece of equipment currently has a queue of actions to be performed, a next action can be scheduled by the scheduler 395 to begin after the current queue of actions is estimated to be completed by the piece of equipment. Likewise, in some embodiments, in response to determining that a particular person within a lab has a queue of actions to perform, a next action can be scheduled by the scheduler 395 to begin being performed by the person after the person is estimated to be completed with the queue of actions associated with the person. In addition, for any actions performed by an actor 840, both manual actions performed by people and autonomous actions performed by equipment, a start of a first action can be scheduled by the scheduler 395 to be performed by an available actor 840 later than a current or next time that the actor 840 is available, for instance, so long as a second action dependent on the first action cannot be scheduled by the scheduler 395 until after the first action is completed. It should be noted that in some embodiments, multiple actions of a same action type across different experiments can be assigned for simultaneous, overlapping, or sequential performance.

In some embodiments, actions within a Python script workflow 830 can be assigned to actors 840 in different labs, in different locations. In such embodiments, code corresponding to different portions of the workflow 830 can be provided to the different labs and locations for execution to perform the actions assigned to the labs. Once assigned, the protocol module 330 configures the equipment to execute the assigned action. Scheduling the performance of the actions by the scheduler 395 in such embodiments can additionally require estimating an amount of time required to transmit data or experiment results from one location to another location, estimating an amount of time required to translate an output from one location into a format or language that a second location can process, and/or estimating an amount of time required for actions performed at least partially simultaneously at multiple locations to be completed.

In some embodiments, estimating an amount of time required to perform an action within a Python script workflow 830 can include applying a machine-learned model, such as a machine learning model 370, to historical performances of the action by an actor 840, either autonomously by equipment or manually by humans. The historical performance data can include historical scheduling data that accounts for a delay before a start in a performance of an action, can include success rate data (such as a number of times an action is attempted before it is successfully performed, by humans and equipment), and can include historical action dependency data (such as a number of historical actions on which other historical actions are dependent on the outcome of). The machine-learned model can be configured to produce an estimated amount of time requirement to perform a future action based on, for instance, available equipment within a lab, experience of people within the lab, and any other characteristic of a Python script workflow 830, an experiment, and/or a set of actions currently scheduled to be performed within the lab. In some embodiments, the machine-learned model is configured to schedule actions within a workflow 830, for instance based on the computed estimated times required to perform each action.

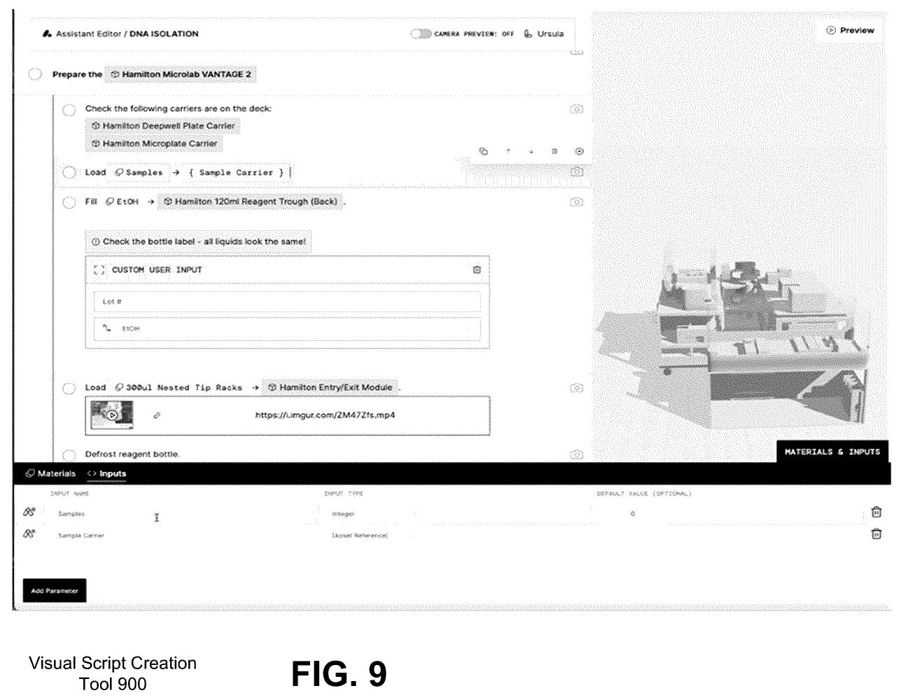

FIG. 9 illustrates an interface for a visual script creation tool 900, according to one embodiment. In some embodiments, the Python scripts 810 described herein can be created using a visual script creation tool 900. In such embodiments, an editor can enable a user to write interactive or manual steps for people and programmatic or autonomous steps for machines or lab equipment within a single document. The visual script creation tool 900 can enable individuals to create the scripts using natural language, invoking particular functions with specified parameters, or via drawn paths by highlighting specific virtual elements and steps.

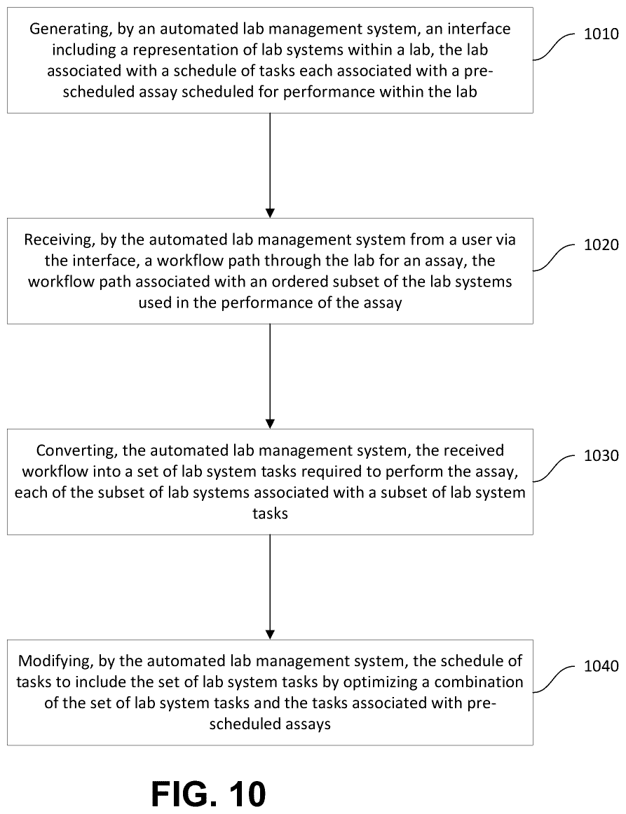

FIG. 10 is a flowchart of an example method for modifying the scheduler to optimize a drawn lab workflow. The automated lab management system generates 1010 an interface including a representation of lab systems within a lab 140. The lab 140 is associated with a schedule of tasks and each task each associated with a pre-scheduled assay scheduled for performance within the lab 140. The interface may be a graphic user interface 500. The automated lab management system is an example of an lab automation system 100. The lab system tasks may include at least one task related to a movement of materials between lab systems within the lab 140. The lab systems may include the robots 150 and the lab equipment 170. The lab systems may include centrifuges, spectrometers, thermocyclers, liquid handling systems, plate readers, incubators, imaging systems, water baths, shakers, and mixers.

The automated lab management system receives 1020, from a user via the interface, a workflow path through the lab 140 for an assay. The workflow path is associated with an ordered subset of the lab systems used in the performance of the assay. The user may be a user 410. The workflow path may be visual workflow path 560 displayed on a graphic user interface 500.

The automated lab management system converts 1030 the received workflow into a set of lab system tasks required to perform the assay, each of the subset of lab systems associated with a subset of lab system tasks. In some embodiments, the automated lab management system identifies any scheduling conflicts between the set of lab system tasks and the tasks associated with pre-scheduled assays and generates an alert to the user via the interface in order to allow the user to modify the workflow path to resolve the identified conflicts. In some embodiments, the automated lab management system provides to the user a recommendation for alternative workflow paths to resolve the identified conflicts. For example, if multiple workflow paths are running within the lab 140 at the same time, and the schedule as currently determined requires more 15 slots of a machine that only has 10 available, the automated lab management system may identify that the machine has a conflict and is over-burdened, and may suggest the use of an variant within the lab 140 with similar capabilities to resolve the conflict.

The automated lab management system modifies 1040 the schedule of tasks to include the set of lab system tasks by optimizing a combination of the set of lab system tasks and the tasks associated with pre-scheduled assays. In some embodiments, the automated lab management system provides recommendations to modify the received workflow path based on criteria including an optimal utilization of lab equipment, a minimization of processing times, and an optimization of lab system output. In some embodiments, the automated lab management system optimizes the combination of the set of lab system tasks and the tasks associated with the pre-scheduled assays based on lab system availability and capacity, assay processing times, and resource allocations within the lab.

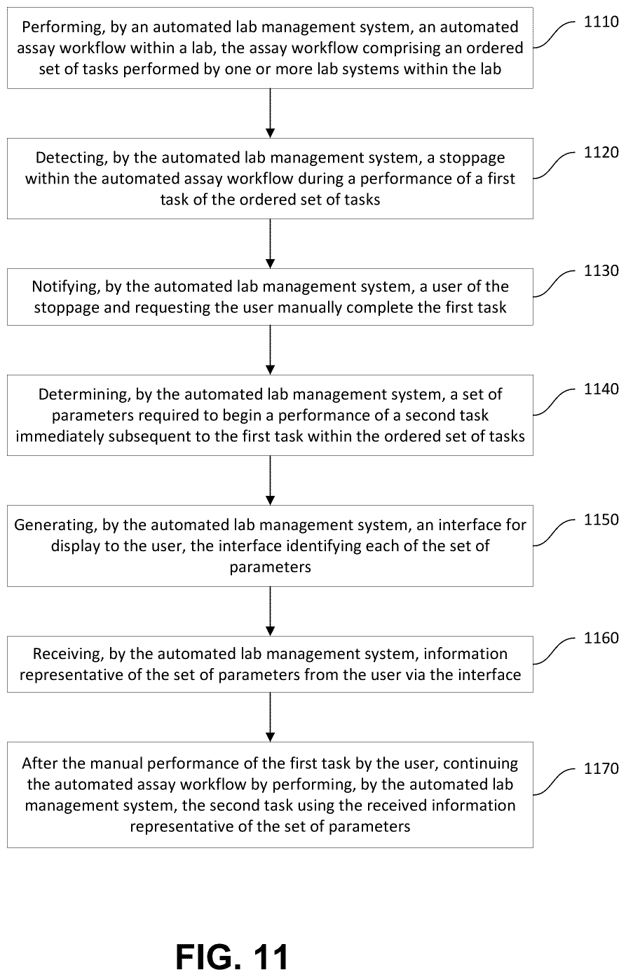

FIG. 11 is a flowchart of an example method for enabling manual data entry for automated workflows. The automated lab management system performs 1110 an automated assay workflow within a lab 140. The assay workflow includes an ordered set of tasks performed by one or more lab systems within the lab 140. The automated lab management system detects 1120 a stoppage within the automated assay workflow during a performance of a first task of the ordered set of tasks. The automated lab management system may identify the stoppage as a stoppage which requires the manual interference and performance of the task by an individual.

The automated lab management system notifies 1130 a user of the stoppage and requesting the user manually complete the first task. In some embodiments, the automated lab management system sends notifications about the stoppage to one or more individuals associated with the automated assay workflow.

The automated lab management system determines 1140 a set of parameters required to begin a performance of a second task immediately subsequent to the first task within the ordered set of tasks. In some embodiments, the automated lab management system identifies mandatory parameters within the set of parameters that must be provided by the user for the automated lab management system to proceed with the second task.

The automated lab management system generates 1150 an interface for display to the user, the interface identifying each of the set of parameters. In some embodiments, the automated lab management system provides default values for the set of parameters not captured by the user during the manual performance of the first task and necessary for the automated lab management system to proceed with the second task.

The automated lab management system receives 1160 information representative of the set of parameters from the user via the interface. In some embodiments, the automated lab management system requires the user to provide a reason for the stoppage before proceeding with the manual performance of the first task, and subsequently storing the reason for the stoppage in a log within the automated lab management system.

After the manual performance of the first task by the user, the automated lab management system continues 1170 the automated assay workflow by performing, by the automated lab management system, the second task using the received information representative of the set of parameters. In some embodiments, the automated lab management system implements a validation process after receiving the information representative of the set of parameters from the user. The validation process is configured to verify accuracy and suitability of provided parameters for the performance of the second task. In some embodiments the automated lab management system includes an optimizer that can either run automatically or be invoked specifically by the user for the management of the automated assay workflow. A description of the stoppage, the cause of the stoppage, and other relevant data may be stored for later diagnostic purposes related to the efficiency and status of equipment within the lab 140.

### Additional Considerations

The foregoing description of the embodiments of the invention has been presented for the purpose of illustration; it is not intended to be exhaustive or to limit the invention to the precise forms disclosed. Persons skilled in the relevant art can appreciate that many modifications and variations are possible in light of the above disclosure.

Some portions of this description describe the embodiments of the invention in terms of algorithms and symbolic representations of operations on information. These algorithmic descriptions and representations are commonly used by those skilled in the data processing arts to convey the substance of their work effectively to others skilled in the art. These operations, while described functionally, computationally, or logically, are understood to be implemented by computer programs or equivalent electrical circuits, microcode, or the like. Furthermore, it has also proven convenient at times, to refer to these arrangements of operations as modules, without loss of generality. The described operations and their associated modules may be embodied in software, firmware, hardware, or any combinations thereof.

Any of the steps, operations, or processes described herein may be performed or implemented with one or more hardware or software modules, alone or in combination with other devices. In one embodiment, a software module is implemented with a computer program product comprising a computer-readable medium containing computer program code, which can be executed by a computer processor for performing any or all of the steps, operations, or processes described.

Embodiments of the invention may also relate to an apparatus for performing the operations herein. This apparatus may be specially constructed for the required purposes, and/or it may include a general-purpose computing device selectively activated or reconfigured by a computer program stored in the computer. Such a computer program may be stored in a non-transitory, tangible computer readable storage medium, or any type of media suitable for storing electronic instructions, which may be coupled to a computer system bus. Furthermore, any computing systems referred to in the specification may include a single processor or may be architectures employing multiple processor designs for increased computing capability.

Embodiments of the invention may also relate to a product that is produced by a computing process described herein. Such a product may include information resulting from a computing process, where the information is stored on a non-transitory, tangible computer readable storage medium and may include any embodiment of a computer program product or other data combination described herein.

Finally, the language used in the specification has been principally selected for readability and instructional purposes, and it may not have been selected to delineate or circumscribe the inventive subject matter. It is therefore intended that the scope of the invention be limited not by this detailed description, but rather by any claims that issue on an application based hereon. Accordingly, the disclosure of the embodiments of the invention is intended to be illustrative, but not limiting, of the scope of the invention, which is set forth in the following claims.

1. A method comprising:
generating, by an automated lab management system, an interface including a representation of lab systems within a lab, the lab associated with a schedule of tasks each associated with a pre-scheduled assay scheduled for performance within the lab;
receiving, by the automated lab management system from a user via the interface, a workflow path through the lab for an assay, the workflow path associated with an ordered subset of the lab systems used in the performance of the assay;
converting, the automated lab management system, the received workflow into a set of lab system tasks required to perform the assay, each of the subset of lab systems associated with a subset of lab system tasks; and
modifying, by the automated lab management system, the schedule of tasks to include the set of lab system tasks by optimizing a combination of the set of lab system tasks and the tasks associated with pre-scheduled assays.

2. The method of claim 1, wherein the lab system tasks include at least one task related to a movement of materials between lab systems within the lab.

3. The method of claim 1, further comprising:
identifying, by the automated lab management system, any scheduling conflicts between the set of lab system tasks and the tasks associated with pre-scheduled assays; and
generating, by the automated lab management system, an alert to the user via the interface, allowing the user to modify the workflow path to resolve the identified conflicts.

4. The method of claim 3, further comprising providing to the user a recommendation for alternative workflow paths to resolve the identified conflicts.

5. The method of claim 1, further comprising providing, by the automated lab management system, recommendations to modify the received workflow path based on criteria including an optimal utilization of lab equipment, a minimization of processing times, and an optimization of lab system output.

6. The method of claim 1, wherein the lab systems comprise one or more members selected from the group consisting of: centrifuges, spectrometers, thermocyclers, liquid handling systems, plate readers, incubators, imaging systems, water baths, shakers, and mixers.

7. The method of claim 1, wherein the automated lab management system optimizes the combination of the set of lab system tasks and the tasks associated with the pre-scheduled assays based on lab system availability and capacity, assay processing times, and resource allocations within the lab.

8. A non-transitory computer-readable medium storing instructions that, when executed by a processor, cause the processor to:
generate, by an automated lab management system, an interface including a representation of lab systems within a lab, the lab associated with a schedule of tasks each associated with a pre-scheduled assay scheduled for performance within the lab;
receive, by the automated lab management system from a user via the interface, a workflow path through the lab for an assay, the workflow path associated with an ordered subset of the lab systems used in the performance of the assay;
convert, the automated lab management system, the received workflow into a set of lab system tasks required to perform the assay, each of the subset of lab systems associated with a subset of lab system tasks; and
modify, by the automated lab management system, the schedule of tasks to include the set of lab system tasks by optimizing a combination of the set of lab system tasks and the tasks associated with pre-scheduled assays.

9. The non-transitory computer-readable medium of claim 8, wherein the lab system tasks include at least one task related to a movement of materials between lab systems within the lab.

10. The non-transitory computer-readable medium of claim 8, further comprising instructions that cause the processor to:
identify, by the automated lab management system, any scheduling conflicts between the set of lab system tasks and the tasks associated with pre-scheduled assays; and
generate, by the automated lab management system, an alert to the user via the interface, allowing the user to modify the workflow path to resolve the identified conflicts.

11. The non-transitory computer-readable medium of claim 10, further comprising instructions that cause the processor to provide to the user a recommendation for alternative workflow paths to resolve the identified conflicts.

12. The non-transitory computer-readable medium of claim 8, further comprising instructions that cause the processor to provide, by the automated lab management system, recommendations to modify the received workflow path based on criteria including an optimal utilization of lab equipment, a minimization of processing times, and an optimization of lab system output.

13. The non-transitory computer-readable medium of claim 8, wherein the lab systems comprise one or more members selected from the group consisting of: centrifuges, spectrometers, thermocyclers, liquid handling systems, plate readers, incubators, imaging systems, water baths, shakers, and mixers.

14. The non-transitory computer-readable medium of claim 8, wherein the automated lab management system optimizes the combination of the set of lab system tasks and the tasks associated with the pre-scheduled assays based on lab system availability and capacity, assay processing times, and resource allocations within the lab.

15. An automated lab management system comprising:
an interface including a representation of lab systems within a lab, the lab associated with a schedule of tasks each associated with a pre-scheduled assay scheduled for performance within the lab, and wherein the interface is configured to receive, by the automated lab management system from a user via the interface, a workflow path through the lab for an assay, the workflow path associated with an ordered subset of the lab systems used in the performance of the assay; and
a processor configured to:
convert the received workflow into a set of lab system tasks required to perform the assay, each of the subset of lab systems associated with a subset of lab system tasks; and
modify the schedule of tasks to include the set of lab system tasks by optimizing a combination of the set of lab system tasks and the tasks associated with pre-scheduled assays.

16. The system of claim 15, wherein the lab system tasks include at least one task related to a movement of materials between lab systems within the lab.

17. The system of claim 15, the processor further configured to:
identify any scheduling conflicts between the set of lab system tasks and the tasks associated with pre-scheduled assays;
generate an alert to the user via the interface, allowing the user to modify the workflow path to resolve the identified conflicts; and
provide to the user a recommendation for alternative workflow paths to resolve the identified conflicts.

18. The system of claim 15, the processor further configured to provide recommendations to modify the received workflow path based on criteria including an optimal utilization of lab equipment, a minimization of processing times, and an optimization of lab system output.

19. The system of claim 15, wherein the lab systems comprise one or more members selected from the group consisting of: centrifuges, spectrometers, thermocyclers, liquid handling systems, plate readers, incubators, imaging systems, water baths, shakers, and mixers.

20. The system of claim 15, wherein the automated lab management system optimizes the combination of the set of lab system tasks and the tasks associated with the pre-scheduled assays based on lab system availability and capacity, assay processing times, and resource allocations within the lab.
